(19) United States
(12) Patent Application Publication
(10) Pub. No.: US 2008/0049011 A1
(43) Pub. Date: Feb. 28, 2008

(54) Surface Mapping Arrangement and Method

(75) Inventor: Gary Fozzard, Leicester (GB)

Correspondence Address: NIXON PEABODY, LLP, 401 9TH STREET, NW, SUITE 900, WASHINGTON, DC, 20004-2128, US

(73) Assignee: Visualize IT LTD., London (GB)

(21) Appl. No.: 10/566,296

(22) PCT Filed: Jul. 28, 2004
(86) PCT No.: PCT/GB04/03269

§ 371 Date: Oct. 10, 2007

(30) Foreign Application Priority Data
Jul. 28, 2003 (GB) 0317642.7

(51) Int. Cl. G06T 15/00; G09G 5/00

(52) U.S. Cl. 345/419; 345/672

(57) ABSTRACT

The present invention concerns a mapping arrangement for defining selected physical characteristics of a surface to be imaged and a method of mapping a surface. The arrangement comprises a template device (6, 7, 8) for temporary application to a surface (2, 3, 4) to be mapped, the template 10 device being configured and constructed such that, when photographed in situ on said surface, it provides a computer supplied with a digital image of the photograph with data from which one or more of the physical characteristics of the surface can be automatically computed, thereby permitting the computer to utilise software, requiring inputs indicative of said characteristics, capable of changing the appearance of the imaged surface in accordance with user selection.

This invention relates to surface mapping arrangements and methods, and it relates more particularly to such arrangements and methods for permitting the capture of selected parameters relating to an environment comprising one or more surfaces, for the purpose of enabling the appearance of a representation of at least one surface in the environment to be changed under user control.

It is known that the appearance of representations of surfaces, such as wall, ceiling and/or floor surfaces, in an environment such as a room of a domestic dwelling, can be changed under user control by means of software applied to a computer which is furnished with a digital image of the room. The image may be, for example, derived from a photograph of the room, or a chosen area of it. The photograph may be taken on a digital camera, enabling direct input to the computer, or it may be a conventional photograph which is scanned into the computer to provide the digital image.

In order to enable a user of the computer to conveniently and accurately apply different surface patterns, textures and/or colouration to the surfaces in question, the software requires the user to input certain critical parameters which define important physical characteristics of the surface or surfaces in question. This mapping operation is difficult and time consuming and in practice deters many people from using the software.

This invention aims to provide an improved mapping arrangement, thereby to reduce the time and effort needed to input these critical data.

According to the invention from one aspect there is provided a mapping arrangement for defining selected physical characteristics of a surface to be imaged, the arrangement comprising a template device for temporary application to said surface; said template device being configured and constructed such that, when photographed in situ on said surface, it provides a computer supplied with a digital image of the photograph with data from which one or more of said physical characteristics can be automatically computed, thereby permitting the computer to utilise software, requiring inputs indicative of said characteristics, capable of changing the appearance of the imaged surface in accordance with user selection.

According to the invention from another aspect there is provided a method of mapping a surface comprising the steps of:
(a) temporarily attaching a template device to the surface;
(b) providing a photograph of said surface with the template device in situ; and
(c) inputting a digital representation of said photograph to a computer provided with software capable, under user control, of changing the appearance of an image of the surface displayed thereby;
   the template device providing the computer with information defining one or more physical characteristics of said surface.

Preferably the template device comprises a sheet carrying markings of known dimensions and at known relative orientations, thereby permitting geometric characteristics of the surface to be accurately defined.

It is further preferred that the said markings include components defining a rectangular frame with opposing sides being substantially parallel, thereby permitting the accurate derivation of perspective data for the surface as photographed. In such circumstances, it is preferred that the parallel sides be substantially aligned with perspective defining edges of said surface.

It is further preferred that at least a portion of the template device is formed to reflect incident light to a predetermined extent, thereby permitting the derivation of suitable brightness data for the surface.

The template device may further comprise a directional indicator to indicate the orientation of patterns or ornamentation incorporated by means of the software into surface treatments to be displayed on the image of said surface.

In order that the invention may be clearly understood and readily carried into effect, one embodiment thereof will now be described, by way of example only, with reference to the accompanying drawings, of which:

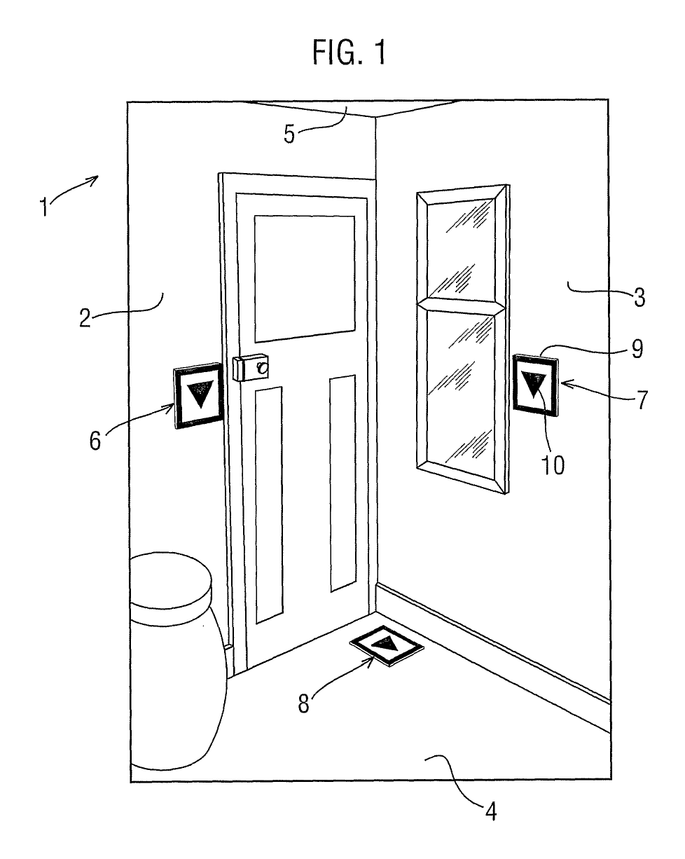

FIG. 1 shows a part of a room, certain surfaces of which are desired to be imaged for the overlay by software of differing surface treatments, and to which surfaces are applied template devices in accordance with aspects of the invention; and

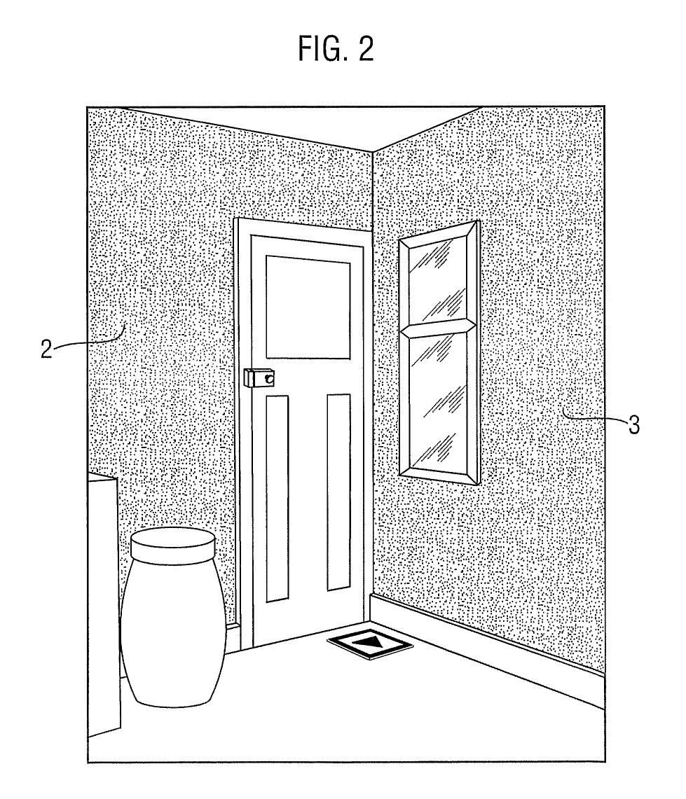

FIG. 2 shows an image of the same part of the room with overlain treatment to some of said surfaces.

As previously mentioned, the intention of the arrangement now to be described is to facilitate, speed up and render more accurate the input of data concerning the physical characteristics of substantially planar surfaces of a room or other area into a computer that is capable of running software that conditions the computer to display one or more of the surfaces overlain with selected surface treatments. A typical objective of the use of such expedients is to enable a home owner to review, effectively in situ, various potential surface treatments, such as paint colours, wallpaper designs and colours, carpeting and the like before redecorating, refurbishing or, indeed, before first decorating or furnishing a room.

It is thus prerequisite that a computer is available to the user and that it is capable of running the software that permits overlaying of colours, patterns and/or textures on surfaces displayed in an image of a room or other area derived from a photograph of the room or area.

Referring now to FIG. 1, a room 1 as viewed from a certain point includes parts of first and second walls 2 and 3, a floor 4 and a ceiling 5. Identical template devices 6, 7 and 8 are temporarily applied respectively to the surfaces of walls 2 and 3 and floor 4; each template device comprising a sheet that bears markings conforming to a rectangular frame or outline 9 with opposing sides being parallel. The template devices 6 and 7 are orientated as shown, such that their respective rectangular frames 9 are disposed with two of their parallel sides aligned substantially parallel to the vertical edges of the respective walls and the other two parallel sides aligned substantially parallel to the horizontal edges of the walls. By this means, the perspective of the wall surfaces, as viewed in the photograph, can be derived, to an acceptable degree of accuracy, by extrapolation from the well defined edges of the frames on the template devices. The vanishing points, or intersection points of projected parallel lines on the surface subjected to the perspective of the photograph, constitute critical physical characteristics of the scene as viewed and their location can, if desired, be improved by iteration or by other known techniques.

The markings such as 9 on the template devices are also constrained to be of known dimensions and thus provide an accurate basis for determination of other important physical characteristics, such as scaling and aspect ratio.

Usefully, the markings on the template devices can also include orientation devices, such as the broad arrows 10, which can be used to indicate the orientation of a pattern or ornament incorporated in a surface treatment to be synthetically overlain on a representation of the selected surface or surfaces.

The sheet material of the template devices such as 6 is also, in this example, selected to have a known reflectance and colouration such that its in situ response to light falling on the surface to which it is (temporarily) applied can be utilised in applying suitable lighting characteristics to the imaged scene when selected overlays are applied to the surface.

It will be appreciated that the computer which is running the overlay software needs to be suitable conditioned to automatically utilise the data derived from the template devices and relating to physical characteristics of the surfaces to develop appropriate measurands and operands, and additional software is supplied for that purpose.

FIG. 2 shows an image of the scene of FIG. 1, with a surface treatment overlain on the walls 2 and 3; this being the desired objective.

It will thus be appreciated that, having decided which surfaces of a room are candidates for computerised texture variation, the user temporarily attaches a template device to each different plane of the surfaces to be mapped and takes a photograph of the room from a desired position.

The photograph, unless taken on a digital camera, needs to be digitised (e.g. by scanning) for input to a computer running the required visualisation software, which guides the user through a sequence of operations designed to select the regions of the image corresponding to the surfaces in question, delineate the outline and mask out any features, such as doors and windows, which are not part of the planned review. The user is also requested, in each case, to identify the template device lying in the same plane as a selected outline. The computer evaluates the relevant physical characteristics, as described above, and the relevant textures can then be superimposed on the image of the scene as displayed, for example, on a screen associated with the computer.

The physical characteristics required by the texture-mapping software typically include vanish points (convergence points of extrapolated perspective lines), calibration data for size mapping and aspect ratio, and area brightness.

These characteristics can, as mentioned above, be generated by the computer from data derived from the template devices.

Regarding the vanish points, the image of the template device is reviewed to identify the corner points of the rectangular frame 9 and these are used in pairs to extrapolate to the vanishing points for the relevant surface. It is preferred to hold these data with sub-pixel accuracy.

In one practical arrangement, the following steps are taken:
a search window is localised on a point clicked by a user to identify the position of the template device;
a sub-image is extracted from the main image;
an edge-detection algorithm is applied;
pixel chainlists are extracted from the edge data using an algorithm that seeks to extract closed shapes;
corners are extracted from the chainlist data so as to identify squares and triangles within the template device; this being achieved in one example by taking account of maximum opening angle within the chainlist and the sum of the angles found at corners within the closed shape;
real templates, as opposed to random shapes in the image, are identified;
the corner points are individually labelled;
linear regression is used to move the corner points to optimise the line of fit to pixel data extracted during the edge detecting operation;
the corner points are adjusted to take account of the direction of any arrowhead such as 10 included as a marking in the template device; and
intersections to calculate the vanish points are made.

Bearing in mind that the user has supplied instructions to the computer defining a closed set of vector outlines for each planar element of each surface to be reviewed and an indication of the template device appropriate to each planar element, the vanish points can be identified with higher accuracy, if desired, by:
searching the list of outline segments for those that appear to project towards the provisional vanish point derived from the template data and excluding those that are short of, or within a set distance beyond, the boundary of the image frame;
using the retained outline segments to calculate the vanish point and the opening angle thereat;
selecting the pair of line segments that optimises the opening angle; and
setting a new vanish point, specific to that mapping region, given by the intersection of the two selected lines.

Once the vanish points have been established to a desired degree of accuracy, a mapping quadrilateral is defined by using the two vanish points for a given planar element, finding the pair of intersecting lines for each that optimises the opening angle and computing the four points of intersection between these two pairs of lines.

It is now possible to establish the true size of the quadrilateral; the first stage in this process being to call up the co-ordinates of the corners of the rectangular marking on the template device. If these are not contained within the dimensions of the mapping quadrilateral, the latter is temporarily expanded to include them. Given the known dimensions of the markings on the template device (e.g. 16 cm sides, measured internally of the rectangle) a calibration factor giving the scale in each direction is established. It is then possible to map a texture to the quadrilateral.

As mentioned previously, the template device can also be used to determine scene brightness. The brightness is adjusted using the fact that white areas of the template have been lit by the ambient lighting conditions within the room. The brightness of pixels falling in the aforesaid white areas is compared to that of pixels in the immediate vicinity of the template device, but outside it, to ascertain the degree of adjustment needed to brighten scene pixels to the same level as those representing the white areas of the template device.

It will be appreciated that the template device can take many different forms and the scope of this invention is not intended to be limited to the specific example shown herein. Moreover, the information relating to the template device and its components may be derived differently, processed differently and utilised differently than described herein.

1. A mapping arrangement for defining selected geometric characteristics of a surface to be imaged, the arrangement comprising a template device for temporary application to said surface; said template device carrying markings of known dimensions and at known relative orientations such that, when photographed in situ on said surface, it provides a computer supplied with a digital image of the photograph with data permitting said geometric characteristics of the surface to be accurately defined by said computer, and thereby permits the computer to utilise software, requiring inputs indicative of said characteristics, capable of changing the appearance of the imaged surface in accordance with user selection.

2. (canceled)

3. An arrangement according to claim 1 wherein the said markings include components defining a rectangular frame with opposing sides being substantially parallel, thereby permitting the accurate derivation of perspective data for the surface.

4. An arrangement according to claim 3 wherein the parallel sides are substantially aligned with perspective defining edges of said surface.

5. An arrangement according to claim 1 wherein at least a portion of the template device is formed to reflect incident light to a predetermined extent, thereby permitting the derivation of suitable brightness data for the surface.

6. An arrangement according to claim 1 wherein the template device further comprises a directional indicator to indicate the orientation of patterns or ornamentation incorporated by means of the software into surface treatments to be displayed on the image of said surface.

7. An arrangement according to claim 6 wherein said directional indicator comprises a broad arrowhead device.

8. (canceled)

9. A method of mapping a surface comprising the steps of:
(a) temporarily attaching to the surface a template device carrying marks of known dimensions and at known relative orientations;
(b) providing a photograph of said surface with the template device in situ; and
(c) inputting a digital representation of said photograph to a computer provided with software capable, under user control, of changing the appearance of an image of the surface displayed thereby;
the template device providing the computer with information permitting one or more geometric characteristics of the surface to be accurately defined by said computer.
